(19) United States
(12) Patent Application Publication
(10) Pub. No.: US 2023/0158561 A1
(43) Pub. Date: May 25, 2023

(54) WASHER AND METHOD FOR MANUFACTURING THE SAME

(71) Applicant: Guan-Hong LIN, Taipei City (TW)

(72) Inventor: Guan-Hong LIN, Taipei City (TW)

(21) Appl. No.: 17/671,945

(22) Filed: Feb. 15, 2022

(30) Foreign Application Priority Data
Nov. 24, 2021 (TW) 110143638

(51) Int. Cl. B21D 53/20; F16B 43/00

(52) U.S. Cl. CPC B21D 53/20; F16B 43/004

(57) ABSTRACT

A method for manufacturing washer includes steps of providing a wire material, deforming part of the wire material to be a ring shape, cutting off the part in the ring shape to obtain a ring-shaped wire material, and forging the ring-shaped wire material into a washer having a split defined by end surfaces at two opposite ends of the ring-shaped wire material.

### CROSS-REFERENCE TO RELATED APPLICATIONS

This non-provisional application claims priority under 35 U.S.C. § 119(a) on Patent Application No(s). 110143638 filed in Taiwan (R.O.C.) on Nov. 24, 2021, the entire contents of which are hereby incorporated by reference.

### TECHNICAL FIELD

The disclosure relates to a washer and method for manufacturing the same, more particularly to a washer having a split and a method for manufacturing the same.

### BACKGROUND

A washer is a fastener used between a nut threadingly connected with a bolt which is introduced into an object including two parts to be assembled. The assembly of nut, bolt, and washer has applications in almost all industries, such as automotive, electrical, medical, appliances, etc.

A typical washer may be manufactured by punching a metal sheet by a punching machine, but after the wanted washers are cut out from the metal sheet, the remaining metal sheet does not have sufficient area for making one more washer and thus it will become scrap. This process also creates a circular scrap left from piercing the metal sheet. As such, punching a metal sheet to manufacture washers results in a large amount of scrap and thereby increasing the manufacturing cost. Another method for manufacturing a washer is by axially punching an end portion of a metal wire, but only some certain large and expensive machines that can provide huge forging force are able to perform this process. Thus, the expense of equipment leads to an even much higher manufacturing cost.

In addition, upon the cases that bolt, nut, and washer are frequently subjected to vibration and other forces, such as vibration caused by wind or the operation of vehicles or equipment, the bolt, nut, and washer will gradually become loose after they have been installed. Some manufacturers had tried to form teeth structures or apply adhesive between the contact surfaces between the washer and the bolt or the nut, or adopted a pair of eccentric nuts to against the vibration, but these solutions are costly and therefore are not favorable for mass production.

### SUMMARY

The disclosure provides a washer and method for manufacturing the same which are capable of offering a cost-effective approach in locking the nut in place against all manner of vibrations.

Accordingly, exemplary embodiments of the disclosure provide a washer with a split and a method for manufacturing the same, where the washer is able to effectively prevent the associated fastener from becoming loose and can be produced through a relatively lower forging force, simpler manufacturing steps, and lower cost but without producing any waste.

One embodiment of the disclosure provides a method for manufacturing washer, including the following steps: providing a wire material; deforming part of the wire material to be a ring shape; cutting off the part in the ring shape to obtain a ring-shaped wire material, wherein two opposite ends of the ring-shaped wire material each have an end surface; forging the ring-shaped wire material into a washer having a split, wherein the split is defined by the end surfaces.

Another embodiment of the disclosure provides a washer including a first contact surface, a second contact surface, a through hole, and two end surfaces. The first contact surface and the second contact surface are located opposite to each other. The through hole penetrates through the first contact surface and the second contact surface and is located at a central axis of the washer. The end surfaces define a split connected to the through hole.

According to the washer and method as discussed in the above embodiments of the disclosure, the washer is manufactured by deforming a wire material, cutting off the deformed wire material, and then forging it to the final shape, thus the method of the disclosure does not involve piercing and therefore does not produce any waste during manufacturing, thereby is especially advantageous in lower cost on material. Also, since the washer is manufactured from a ring-shaped wire material, there is no need to adopt the forging machine that can provide a huge forging force required to directly punch a hole from a wire material. In other words, the method illustrated in the disclosure makes it possible that a washer of same function can be manufactured by a significantly smaller forging force. As such, the washer and method of the disclosure have lower requirements for forging force and do not produce waste during manufacturing thus are favorable for reducing the cost in equipment and material and thereby achieving economic mass production.

Optionally, at least one surface of the washer of the disclosure used to contact with nut is inclined, which is able to cause the nut to create an additional torque with respect to the threads of the bolt when the nut is tightened. As such, the nut can be more firmly intermeshed with the bolt and thus helping prevent all manner of vibrations from causing the bolt and nut to rotate relative to each other; that is, the inclined contact surface of the washer is able to stabilize and further secure the engagement between the nut and bolt to increase the resistance of the nut from loosening with respect to the bolt. In contrast to the prior art that forms a complex profile or teeth structure on the contact surfaces between the washer and the nut, the manufacturing method of the disclosure does not involve complex process or die design and thus can produce a washer with lower cost. In short, the washer of the disclosure has a simple configuration to effectively minimize the tendency of the nut to loosen by undesired rotation with respect to the washer, achieving an easily feasible and low-cost manufacturing process and thus is more competitive.

### BRIEF DESCRIPTION OF THE DRAWINGS

The present disclosure will become better understood from the detailed description given hereinbelow and the accompanying drawings which are given by way of illustration only and thus are not intending to limit the present disclosure and wherein:

FIG. 1 is an exploded view of a washer according to one embodiment of the disclosure and the associated bolt and nut;

FIG. 2 is a cross-sectional view of a washer according to one embodiment of the disclosure when being applied to a bolt and a nut;

FIG. 3 is a perspective view of the washer in FIG. 2;

FIG. 4 is a cross-sectional view of the washer in FIG. 3;

FIG. 5 is a cross-sectional view of a washer according to another embodiment of the disclosure;

FIG. 6 shows the steps of manufacturing the washer according to one embodiment of the disclosure;

FIGS. 7-9 respectively depict the steps of manufacturing the washer according to one embodiment of the disclosure;

FIG. 10 is a perspective view of a washer according to another embodiment of the disclosure;

FIG. 11 is a cross-sectional view of the washer in FIG. 10;

FIGS. 12-17 depict washers with different shapes of end surfaces produced by manufacturing methods according to different embodiments of the disclosure;

FIGS. 18-20 depict washers produced by manufacturing methods according to different embodiments of the disclosure; and

FIG. 21 depicts a washer according to one embodiment of the disclosure is cooperated with a typical washer.

### DETAILED DESCRIPTION

Aspects and advantages of the disclosure will become apparent from the following detailed descriptions with the accompanying drawings. The inclusion of such details provides a thorough understanding of the disclosure sufficient to enable one skilled in the art to practice the described embodiments but it is for the purpose of illustration only and should not be understood to limit the disclosure. On the contrary, it is intended to cover alternatives, modifications, and equivalents as can be included within the spirit and scope of the described embodiments as defined by the appended claims. To this end, those skilled in the relevant art will recognize and appreciate that many changes can be made to the various aspects of the disclosure described herein, while still obtaining the beneficial results of the present disclosure. It will also be apparent that some of the desired benefits of the present disclosure can be obtained by selecting some of the features of the present disclosure without utilizing other features.

It is to be understood that the phraseology and terminology used herein are for the purpose of better understanding the descriptions and should not be regarded as limiting. Unless specified or limited otherwise, the terms “mounted,” “connected,” and variations thereof are used broadly and encompass both direct and indirect mountings and connections. As used herein, the terms “substantially” or “approximately” may describe a slight deviation from a target value, in particular a deviation within the production accuracy and/or within the necessary accuracy, so that an effect as present with the target value is maintained. Unless specified or limited otherwise, the phrase “at least one” as used herein may mean that the quantity of the described element or component is one or more than one but does not necessarily mean that the quantity is only one. The term “and/or” may be used herein to indicate that either or both of two stated possibilities.

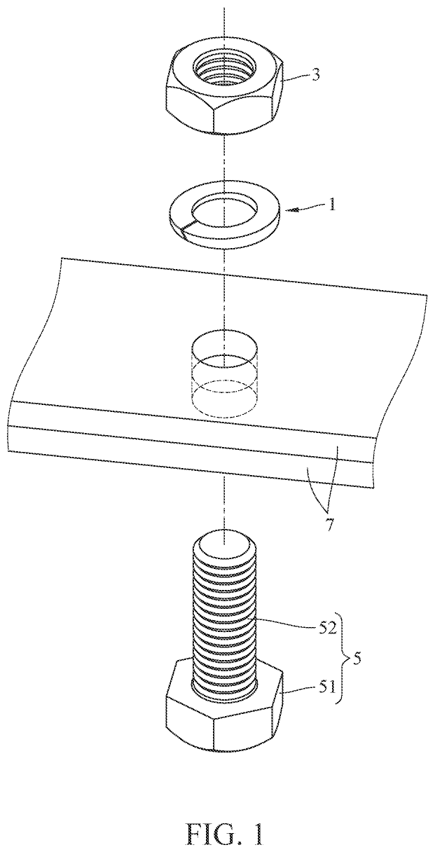

The following exemplary embodiments will be described with reference to FIGS. 1-21. For ease of explanation, some elements shown in the drawings may be simplified or illustrated by dotted lines while other elements irrelevant to the spirit of the disclosure may be omitted.

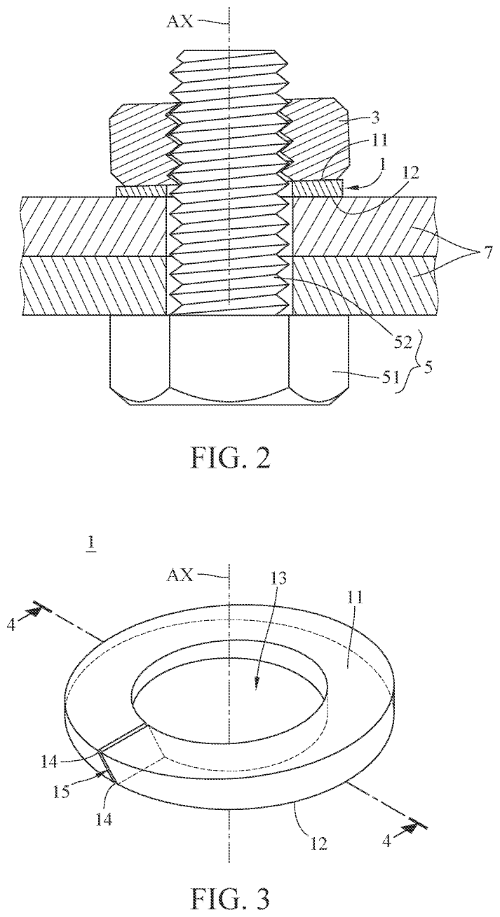

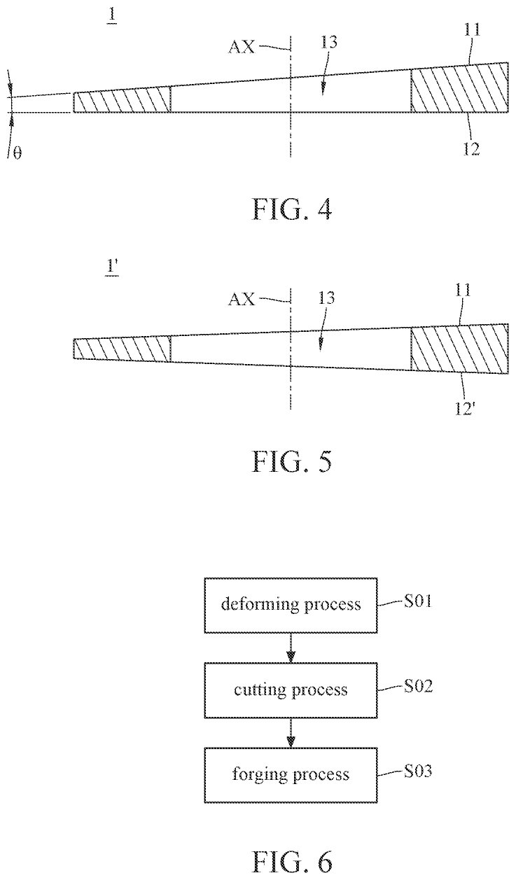

Firstly, referring to FIGS. 1-4, one embodiment of the disclosure provides a washer 1, where FIG. 1 depicts an exploded view of a washer 1 according to one embodiment of the disclosure and an associated bolt 5 and nut 3, FIG. 2 depicts a cross-sectional view of the assembly of the washer 1, the bolt 5, and the nut 3, FIG. 3 depicts a perspective view of the washer 1, and FIG. 4 depicts a cross-sectional view of the washer 1. The washer 1 has a split 15; in other words, the washer 1 can be considered as a split washer.

As shown in FIGS. 1-2, the bolt 5 can be disposed through two or more workpieces 7, and the nut 3 and the washer 1 can be applied to the part of the bolt 5 penetrating out of one or more workpieces 7, where the washer 1 can be served as a spacer located between and clamped by the nut 3 and one of the workpieces 7. The arrangement or assembly of the bolt 5, nut 3, and washer 1 is able to secure the assembly of the workpieces 7.

In specific, the bolt 5 may include a head 51 and a threaded stud 52 extends outward from the head 51, the threaded stud 52 can be disposed through the workpieces 7, the washer 1 can be sleeved on the part of the threaded stud 52 penetrating out of the workpieces 7, and then the nut 3 can be screwed on the threaded stud 52 so that the workpieces 7 can be clamped and assembled by the head 51 and the washer 1 and the nut 3. Note that the nut 3 and the bolt 5 are exemplary but not intended to limit the disclosure and the washer 1 is suitable for any typical nut and bolt. The workpieces 7 can be any two parts needed to be assembled by the arrangement of the washer 1, the bolt 5, and the nut 3 and are not intended to limit the disclosure. For example, the workpieces 7 may be but are not limited to be parts of the same or different components, equipment, devices.

Generally, the washer 1 not only can distribute the load to prevent damage to the surface being fixed but also can prevent the loss of pre-load so as to prevent loosening by unscrewing rotation of the fastening device due to all manner of vibrations. The details of the washer 1 are given below.

The washer 1 is a piece usually thin, having a centrally located hole. The washer 1 may be integrally made of any suitable plastic or metal. In specific, as shown in FIGS. 3-4, the washer 1 has a first contact surface 11 and a second contact surface 12, the first contact surface 11 and the second contact surface 12 are two opposite surfaces of the washer 1 that are configured to contact the surface of nut 3 or workpieces 7. The washer 1 has a through hole 13 penetrating through the first contact surface 11 and the second contact surface 12 for the insertion of the threaded stud 52 of the bolt 5. The through hole 13 is located at a central axis AX of the washer 1. Note that the size, position, and shape of the through hole 13 may be modified as required by the bolt that the washer 1 cooperates with. The central axis AX is an imaginary line substantially parallel to an inner annular surface (not numbered) that defines the through hole 13. The central axis AX is also parallel to the inserting direction of the threaded stud 52 of the bolt 5 to the washer 1.

In one embodiment, the first contact surface 11 may be at an angle to the second contact surface 12; in this case, at least one of the first contact surface 11 and the second contact surface 12 has a normal line (not shown) not parallel to the central axis AX; in other words, at least one of the first contact surface 11 and the second contact surface 12 is an inclined surface relative to the central axis AX. Alternatively, in another embodiment, the first contact surface 11 and the second contact surface 12 may be parallel to each other; in this case, both the first contact surface 11 and the second contact surface 12 have a normal line substantially parallel to the central axis AX. In other words, in either case, at least one of the first contact surface 11 and the second contact surface 12 has a normal line substantially parallel to the central axis AX. In the former case, as shown in FIG. 4, the first contact surface 11 and the second contact surface 12 are not parallel to each other, and the first contact surface 11 is at an angle θ to the second contact surface 12; in specific, the first contact surface 11 may be inclined relative to the central axis AX. In one example, the angle θ may range between 1° and 7°; in another example, the angle θ may range between 3° and 7°.

Note that the angle between the first contact surface 11 and the second contact surface 12 may be modified as required or according to metric standards so as to fit the required strength and size level: in a case that the washer of one embodiment of the disclosure is applied to a bolt in property class 8.8 and having threads in M4, the first contact surface and the second contact surface may have an angle ranging between 5° and 6°; in another case that the washer of one embodiment of the disclosure is applied to a bolt in property class 8.8 or 10.9 and having threads in M4-M24, the first contact surface and the second contact surface may have an angle ranging between 3° and 5°; in another case that the washer of one embodiment of the disclosure is applied to a bolt in property class 12.9 and having threads in M24, the first contact surface and the second contact surface may have an angle ranging between 2° and 3°.

As shown in FIG. 2, when the nut 3 intermeshes with the threaded stud 52 of the bolt 5 and is to be tightened to the washer 1, the nut 3 will eliminate the gaps between the threads at one side thereof and the threaded stud 52 and becomes inclined relative to the threaded stud 52 in order to fully contact the inclined surface (e.g., the first contact surface 11) of the washer 1. The aforementioned gaps may appear due to the manufacturing tolerance of both the nut thread profile and the bolt thread profile, thus the gaps are understandably inevitable and can be considered as a neglectable deviation. The inclination of the nut 3 relative to the threaded stud 52 produces an additional torque to the threaded stud 52 as the nut 3 is further tightened to the threaded stud 52. The produced torque results in more thread interference between the nut 3 and the threaded stud 52 so as to improve the resistance to a loosening torque due to vibration. In short, due to the inclined contact surface of the washer 1, the nut 3 and the bolt 5 can have a higher initial tightening torque (installation torque) to resist the unscrewing motion and become effective against all manner of vibrations, thereby securing and stabilizing the assembly of the fastened workpieces.

As illustrated, the washer 1 is assembled between the bearing surface of the nut 3 and the workpiece 7 being attached, thus, the washer 1 still can make the nut 3 inclined relative to the threaded stud 52 to achieve the same effect when the first contact surface 11 is facing towards the workpiece 7. That is, the washer 1 can be installed in either direction and therefore is foolproof and convenient to use.

Note that the washer of the disclosure may have both surfaces inclined. For example, please see a washer 1′ as illustrated in FIG. 5, the washer 1′ having a second contact surface 12′ whose normal line is not parallel to the central axis AX, that is, the first contact surface 11 and the second contact surface 12′ of the washer 1′ are both inclined relative to its central axis AX. This configuration of the washer 1′ also can prevent the nut from loosening.

In a conventional approach to apply adhesive between the nut and bolt for the purpose of anti-loosing, the application of the adhesive incur additional cost and the adhesive will break down overtime, thus adhesive is not a reliable and cost-effective way to prevent loosening. Another conventional approach for the same purpose is to form a complex profile or teeth structure on the bearing surfaces of the bolt, nut, or washer, but it involves complex processes and die design to produce and thus resulting in high manufacturing costs. On the other hand, the washer as illustrated in any one of the previous embodiments of the disclosure is able to effectively prevent the bolt and nut from loosening simply by having one of the contact surfaces inclined, thus the washer of the disclosure is apparently more competitive in reducing manufacturing and material costs.

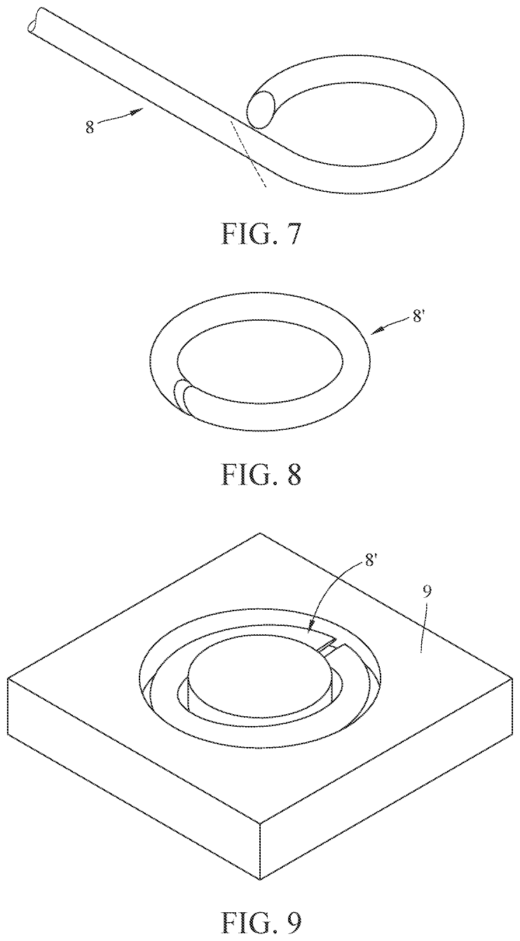

In addition, the configuration of the washer of the disclosure allows it to be manufactured without producing waste scraps and with a lower requirement for the equipment level. The specific detail will be provided below with reference to FIGS. 6-9, where FIG. 6 shows the steps of manufacturing the washer according to one embodiment of the disclosure, and FIGS. 7-9 respectively depict the steps of manufacturing the washer according to one embodiment of the disclosure.

Firstly, in FIG. 6, the method for manufacturing the washer of any one of the previous embodiments may at lease include a deforming process (step S01), a cutting process (S02), and a forging process (step S03). In specific, as shown in FIG. 7, a wire material 8 is provided, the wire material 8 has a proper diameter and is made of the material typically used to produce a washer. Note that the length and size of the wire material 8 are for the explanation only but not intended to limit the disclosure. In step S01, part of the wire material 8 may be deformed into a circular or ring shape by any suitable means. The part of the wire material 8 in the circular shape will be transformed into a washer by the following steps.

Then, in step S02, as shown in FIGS. 7 to 8, the part in the circular shape is cut off from the wire material 8 by any suitable means. In other words, part of the wire material 8 is shaped and separated from the rest part to become a ring-shaped wire material 8′. The incision (not numbered) on the ring-shaped wire material 8′ is, for example, inclined, but its shape and inclination may be modified as required.

Then, in step S03, as shown in FIG. 9, the ring-shaped wire material 8′ may be placed into a die 9 which has a cavity having a contour the same as a washer of the embodiment of the disclosure. The ring-shaped wire material 8′ in the die 9 then can be turned into the required washer by an open-die forging process. In specific, during the forging process, the ring-shaped wire material 8′ is hammered or pressed in a direction parallel to the radial direction of the solid part thereof; in other words, the ring-shaped wire material 8′ is flattened by the force in the axial direction of circular shape, causing the ring-shaped wire material 8′ to flow and fill the cavity of the die 9 and finally to be turned into the washer as illustrated in one of the embodiments of the disclosure.

Now it is already known that the washer 1 was transformed from a split ring-shaped wire material 8′, thus, referring back to FIG. 3, the manufacturing process leaves a split 15 on the washer 1. As shown, the split 15 is defined by two end surfaces 14 which are not parallel to the first contact surface 11 and the second contact surface 12 and connected to the through hole 13. More specifically, it is known that the washer 1 was produced by forging the ring-shaped wire material 8′, thus the end surfaces 14 of the washer 1 that define the split 15 may be aligned with each other and have mating shapes. As shown, the end surfaces 14 each is a planar inclined surface so that the split 15 is inclined as well. Note that the split 15 illustrated in the drawings may be slightly enlarged for easier viewing, but it actually may be smaller and the end surfaces 14 may be in direct contact with each other.

Compared to the conventional manufacturing processes of die stamping on a metal sheet and piercing the forged wire material, the manufacturing method of the disclosure does not produce any scrap and can be performed by forging force not as large as the conventional forging process.

Specifically, a conventional washer may be manufactured by punching a metal sheet by a punching machine, but after the wanted washers are cut off from the metal sheet, the remaining metal sheet does not have sufficient area for making one more washer and thus it will become scrap. Also, this process also creates a circular scrap left from piercing the metal sheet. As a result, for producing washers, each metal sheet will have about 60% unusable scrap.

A conventional washer may be manufactured by axially punching and piercing an end portion of a metal wire, but piercing still will create scrap (about 20% of the end portion will be discarded). Also, only some certain large and expensive machines that can provide huge forging force are able to realize this process. Generally, axially punching a straight part of a metal wire into the required shape at least needs a forging force of more than a hundred tons. For example, to manufacture a washer which is applicable to a bolt having threads in M24, the needed forging force must go up to near 180 tons, it is known that only some certain large and expensive machines have this capability. As a result, the equipment cost and requirements lead to an even much higher manufacturing cost.

On the other hand, the manufacturing method according to the disclosure only involve deforming a wire material, cutting off the deformed wire material, and then forging it to the final shape, which has no need to perform piercing and thus does not produce any scrap. Also, the manufacturing method according to the disclosure manufactures a washer by forging a ring-shaped wire material in the radial direction of the solid part thereof, thus the forge force needed in the method of the disclosure is significantly lower. For example, the method of the disclosure only needs a forging force of about 80 tons to manufacture a washer which is applicable to a bolt having threads in M24, allowing the washer to be manufactured by a cheaper and smaller forging machine. As such, the washer and method of the disclosure have lower requirements for forging force and do not produce waste during manufacturing thus are favorable for reducing the cost in equipment and material and thereby achieving economic mass production.

In addition, in this embodiment, the end surfaces 14 which define the split 15 are not parallel to the central axis AX; in other words, the end surfaces 14 illustrated in FIG. 13 are inclined relative to both the first contact surface 11 and the second contact surface 12. When the washer 1 is applied to other fasteners as shown in FIG. 1, the existence of the inclined end surfaces 14 permits the washer 1 to be slightly deformed by the rotation of the nut 3, such that the end surfaces 14 may contact each other to eliminate the gap therebetween and help the nut 3 further tightened to the threaded stud 52.

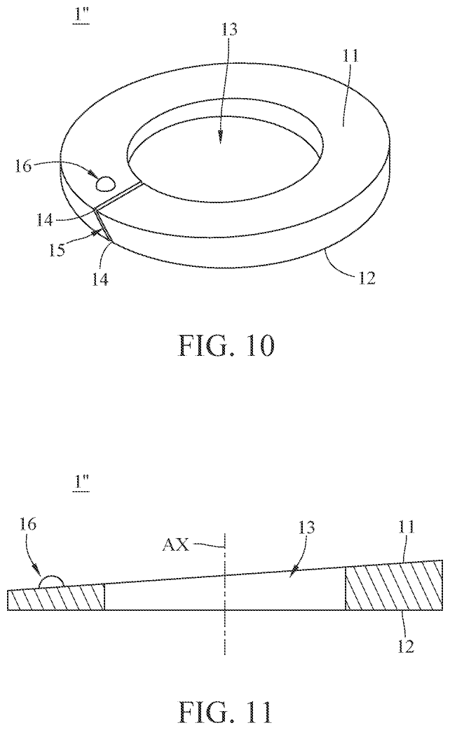

Additionally or optionally, referring to FIGS. 10-11, another embodiment of the disclosure provides a washer 1″, at least one of the first contact surface 11 and the second contact surface 12 of the washer 1″ has at least one bump 16 protruding thereon. The bump 16 may be integrally formed on the washer 1″ or additionally attached to the washer 1″. When the washer 1″ is tightened to the workpiece 7 by the nut 3, the bump 16 can strengthen the connection between the washer 1″ and the workpiece 7 or the nut 3. In another embodiment, the bump 16 may contain pigment therein and is crushable by a certain amount of force; thus, when the washer 1″ is tightened to the workpiece 7 by the nut 3, the force applied to the bump 16 can crush it and squeeze out the pigment for the user to make sure whether the nut 5 is tightened as required. Note that the washer in another embodiment may have two or more than two bumps thereon.

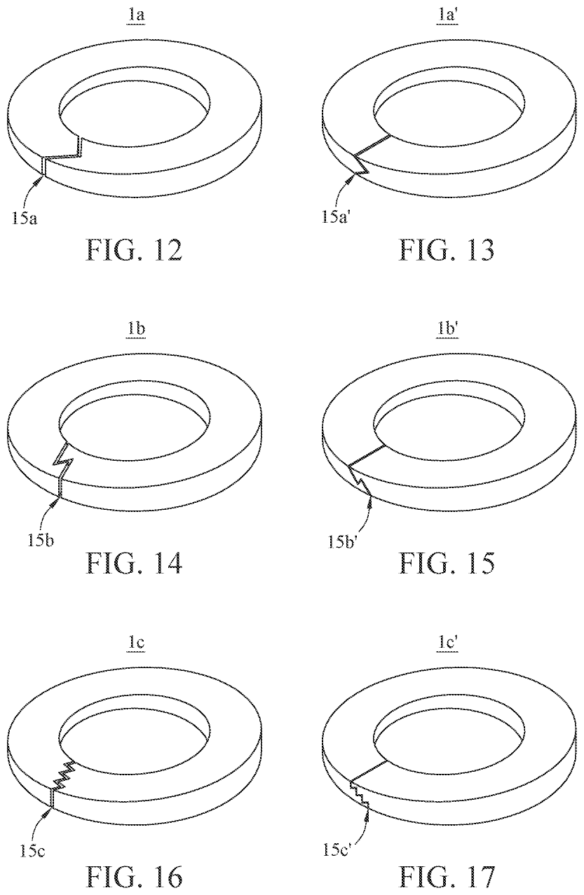

Note that the shape of the split or end surfaces of the washer of the disclosure may be modified as required. Referring to FIG. 12, one embodiment of the disclosure provides a washer 1a having a split 15a in a pointy shape which was formed by axially cutting off the deformed wire material during the aforementioned cutting process. Alternatively, referring to FIG. 13, one embodiment of the disclosure provides a washer 1a having a split 15a′ in a pointy shape which was formed by radially cutting off the deformed wire material during the aforementioned cutting process. Alternatively, referring to FIG. 14, one embodiment of the disclosure provides a washer 1b having a split 15b in a zigzag shape which was formed by axially cutting off the deformed wire material during the aforementioned cutting process. Alternatively, referring to FIG. 15, one embodiment of the disclosure provides a washer 1b′ having a split 15b′ in a zigzag shape which was formed by radially cutting off the deformed wire material during the aforementioned cutting process. Alternatively, referring to FIG. 16, one embodiment of the disclosure provides a washer 1c having a split 15c in a zigzag shape with more steps which was formed by axially cutting off the deformed wire material during the aforementioned cutting process. Alternatively, referring to FIG. 17, one embodiment of the disclosure provides a washer 1c′ having a split 15c′ in a zigzag shape with more steps which was formed by radially cutting off the deformed wire material during the aforementioned cutting process. Note that the aforementioned exemplary shapes of splits can increase the engagement between the end surfaces when the washer is experiencing load so as to further improve the stability and structural strength of the washer.

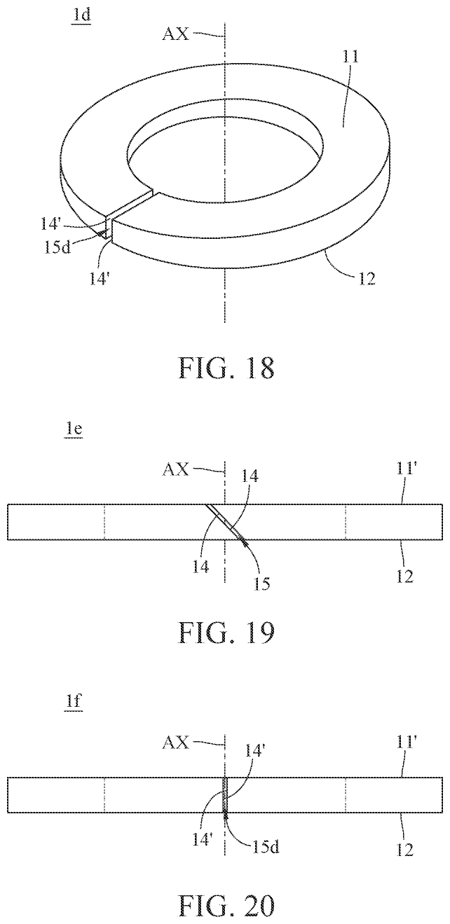

Alternatively or optionally, referring to FIG. 18, another embodiment of the disclosure provides a washer 1d having a split 15d defined by two vertical end surfaces 14′; in specific, the split 15d and the end surfaces 14′ defining it are substantially parallel to the central axis AX of the washer 1d. In other words, the split 15d and the end surfaces 14′ are not inclined relative to the central axis AX of the washer 1d, and the split 15d and the end surfaces 14′ are substantially perpendicular to at least one of the first contact surface 11 and the second contact surface 12.

Note that the opposite contact surfaces of the washer of the disclosure may be parallel to each other. For example, referring to FIG. 19, another embodiment of the disclosure provides a washer 1d having a first contact surface 11′ and a second contact surface 12 substantially parallel to each other. Further, any one of the aforementioned splits may be applied to the washer with two parallel contact surfaces. For example, referring to FIG. 20, another embodiment of the disclosure provides a washer 1f, the washer 1f has a first contact surface 11′ and a second contact surface 12 parallel to each other and also has a split 15d as illustrated in FIG. 18.

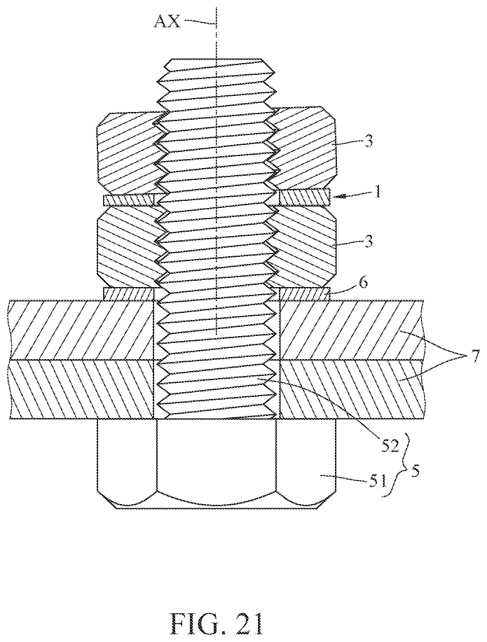

It is noted that any one the washers illustrated in the previous embodiments of the disclosure can be flexibly applied to any typical nut and bolt. For example, referring to FIG. 21, a typical washer 6 is applied between the workpiece 7 and one of the nuts 3, and the washer 1 is applied between the nuts 3, as discussed above, the inclined contact surface of the washer 1 can cause the other nut 3 to slightly incline relative to the threaded stud 52, thus the washer 1 still can prevent the unscrewing rotation of the nut 3 due to all manner of vibrations

According to the washer and method as discussed in the above embodiments of the disclosure, the washer is manufactured by deforming a wire material, cutting off the deformed wire material, and then forging it to the final shape, thus the method of the disclosure does not involve piercing and therefore does not produce any waste during manufacturing, thereby is especially advantageous in lower cost on material. Also, since the washer is manufactured from a ring-shaped wire material, there is no need to adopt the forging machine that can provide a huge forging force required to directly punch a hole from a wire material. In other words, the method illustrated in the disclosure makes it possible that a washer of same function can be manufactured by a significantly smaller forging force. As such, the washer and method of the disclosure have lower requirements for forging force and do not produce waste during manufacturing thus are favorable for reducing the cost in equipment and material and thereby achieving economic mass production.

Optionally, at least one surface of the washer of the disclosure used to contact with nut is inclined, which is able to cause the nut to create an additional torque with respect to the threads of the bolt when the nut is tightened. As such, the nut can be more firmly intermeshed with the bolt and thus helping prevent all manner of vibrations from causing the bolt and nut to rotate relative to each other; that is, the inclined contact surface of the washer is able to stabilize and further secure the engagement between the nut and bolt to increase the resistance of the nut from loosening with respect to the bolt. In contrast to the prior art that forms a complex profile or teeth structure on the contact surfaces between the washer and the nut, the manufacturing method of the disclosure does not involve complex process or die design and thus can produce a washer with lower cost. In short, the washer of the disclosure has a simple configuration to effectively minimize the tendency of the nut to loosen by undesired rotation with respect to the washer, achieving an easily feasible and low-cost manufacturing process and thus is more competitive.

It will be apparent to those skilled in the art that various modifications and variations can be made to the present disclosure. It is intended that the specification and examples be considered as exemplary embodiments only, with a scope of the disclosure being indicated by the following claims and their equivalents.

What is claimed is:

1. A method for manufacturing washer, comprising:
providing a wire material;
deforming part of the wire material to be a ring shape;
cutting off the part in the ring shape to obtain a ring-shaped wire material, wherein two opposite ends of the ring-shaped wire material each have an end surface; and
forging the ring-shaped wire material into a washer having a split defined by the end surfaces.

2. The method according to claim 1, wherein the step of forging the ring-shaped wire material comprises: providing forging force in a radial direction of a solid part of the ring-shaped wire material to the ring-shaped wire material.

3. The method according to claim 1, wherein the step of forging the ring-shaped wire material comprises: providing forging force in an axial direction of the ring shape to the ring-shaped wire material.

4. The method according to claim 1, wherein the step of cutting off the part in the ring shape comprises: cutting off the part in the ring shape in a radial or axial direction of the ring shape so that at least one of the end surfaces of the ring-shaped wire material is in a pointy shape or a zigzag shape.

5. The method according to claim 1, wherein the washer has a first contact surface and a second contact surface located opposite to each other, the first contact surface and the second contact surface are not parallel to each other, and the first contact surface is at an angle ranging between 3° and 7° to the second contact surface.

6. The method according to claim 5, wherein the washer further comprises a through hole located at a central axis of the washer, at least one of the first contact surface and the second contact surface is not parallel to the central axis.

7. The method according to claim 5, wherein the washer further comprises a through hole located at a central axis of the washer, both the first contact surface and the second contact surface are not parallel to the central axis.

8. The method according to claim 1, wherein the washer having a first contact surface and a second contact surface located opposite to each other, at least one of the first contact surface and the second contact surface has at least one bump thereon.

9. The method according to claim 8, wherein the at least one bump has a pigment therein.

10. The method according to claim 1, wherein the washer has a first contact surface and a second contact surface located opposite to each other, each of the end surfaces is inclined with respect to both the first contact surface and the second contact surface.

11. A washer, comprising:
a first contact surface and a second contact surface located opposite to each other;
a through hole, penetrating through the first contact surface and the second contact surface and located at a central axis of the washer; and
two end surfaces, defining a split connected to the through hole.

12. The washer according to claim 11, wherein the first contact surface and the second contact surface are not parallel to each other, and the first contact surface is at an angle ranging between 3° and 7° to the second contact surface.

13. The washer according to claim 12, wherein at least one of the first contact surface and the second contact surface is not parallel to the central axis.

14. The washer according to claim 12, wherein both the first contact surface and the second contact surface are not parallel to the central axis.

15. The washer according to claim 11, wherein at least one of the first contact surface and the second contact surface has at least one bump thereon.

16. The washer according to claim 15, wherein the at least one bump has a pigment therein.

17. The washer according to claim 11, wherein the end surfaces are aligned with each other and have mating shapes each other.

18. The washer according to claim 11, wherein each of the end surfaces is inclined with respect to both the first contact surface and the second contact surface.
